(19) United States
(12) Patent Application Publication
(10) Pub. No.: US 2019/0346901 A1
(43) Pub. Date: Nov. 14, 2019

(54) USAGE PATTERNS TO KEEP A DISPLAY ON

(71) Applicant: HEWLETT-PACKARD DEVELOPMENT COMPANY, L.P., Spring, TX (US)

(72) Inventor: Mohit GUPTA, San Diego, CA (US)

(21) Appl. No.: 16/340,275

(22) PCT Filed: Feb. 3, 2017
(86) PCT No.: PCT/US2017/016389

§ 371 Date: Apr. 8, 2019

(51) Int. Cl. G06F 1/3206; G06F 1/3234; G06F 1/3287; G06F 1/16

(52) U.S. Cl. CPC G06F 1/3206; G06F 1/3265; G06F 1/166; G06F 1/1694; G06F 1/3287

(57) ABSTRACT

In example implementations, a method is provided. The method includes learning a usage pattern during a learning period that collects device positions and contextual information during use of a device. The usage pattern is detected during use of the device after the learning period. An auto lock feature of the device is disabled to keep a display of the device on during the usage pattern in response to detecting the usage pattern.

### BACKGROUND

Portable electronic devices have become ubiquitous. Portable electronic devices operate on battery power and are used to consume various types of media and execute various types of software applications. To conserve battery power, the portable electronic devices may employ various different battery power saving programs and functions. For example, after a period of inactivity, the portable electronic device may go into a sleep mode, and so forth.

### BRIEF DESCRIPTION OF THE DRAWINGS

FIG. 1 is a block diagram of an example device of the present disclosure;

FIG. 2 is a detailed block diagram of the example device of the present disclosure;

FIG. 3 is a block diagram of an example method for keeping a display of a device on; and

FIG. 4 is a block diagram of a non-transitory computer readable medium storing instructions executed by a processor, according to an example.

### DETAILED DESCRIPTION

The present disclosure discloses methods and devices for keeping a display on. As discussed above, portable electronic devices operate on battery power and are used to consume various types of media and execute various types of software applications. To conserve battery power, the portable electronic devices may employ various different battery power saving programs and functions. For example, after a period of inactivity, the portable electronic device may turn off a display to conserve battery power. After another period of inactivity, the portable electronic device may go into a sleep mode, and so forth.

However, certain uses of the portable electronic device can lead to periods of inactivity that are greater than a display off timer associated with an auto lock feature that may cause the display to turn off or power down. For example, a user may be reading a document, watching a program, looking at a photo, and the like, that may not register any activity on the device and cause the device to activate the auto lock feature. Thus, the user may experience frustration from the display turning off due to inactivity detected by the device, even though the device is being used.

The examples of the present disclosure provide a method and a device that keeps a display on during certain learned usage patterns that may otherwise be identified by the device as inactivity that would cause an auto lock feature to be activated. In other words, based on a device position and contextual information that are collected during a learning period, the device may learn usage patterns of the device that indicate that the display should be kept on during the use even though it may appear that the device is inactive. In other words, the device may learn certain usage patterns that may temporarily override an auto lock feature until the usage pattern is no longer detected.

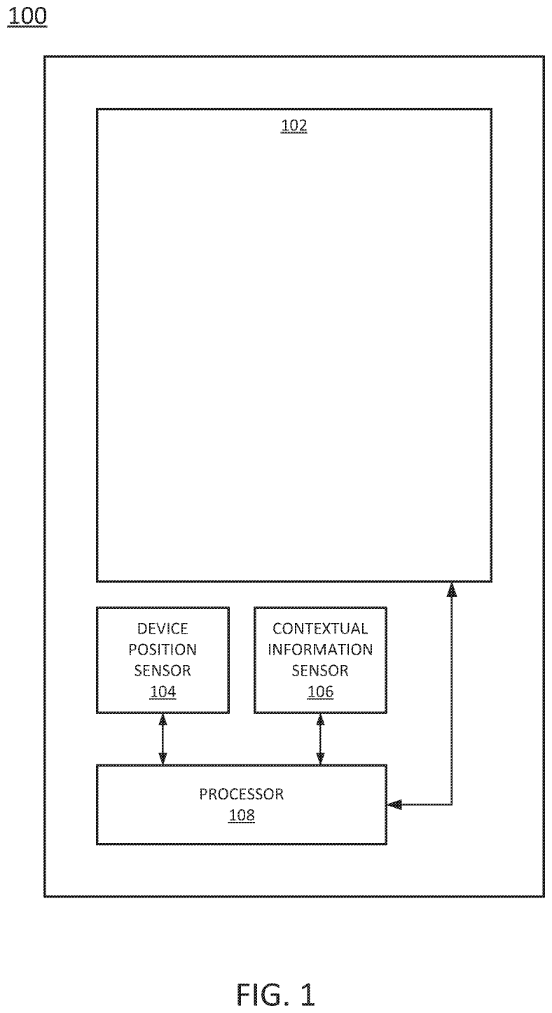

FIG. 1 illustrates a block diagram of an example device 100 of the present disclosure. The device 100 may be a portable electronic device that is battery operated, such as for example, a smart phone, a tablet computer, a touchscreen device, a laptop computer, and the like.

In one example, the device 100 may include a display 102, at least one first sensor 104, at least one second sensor 106 and a processor 108. The processor may be in communication with the at least one first sensor 104, the at least one second sensor 106 and the display 102. The processor 108 may receive information or data collected by the at least one first sensor 104 and the at least one second sensor 106 and analyze the data or information to control operation of the display 102. For example, the processor 108 may turn the display 102 on and off, increase or decrease a brightness of the display 102, or other modify other parameters associated with the display 102 (e.g., color, contrast, resolution, refresh rate, and the like).

In one example, the at least one first sensor 104 may be a device position sensor. For example, the device position sensor may collect information related to a position of the device 100 such as a tilt angle, an orientation and carry position or placement of the device 100. In one example, the tile angle may be an angle at which the device 100 is rotated away from or towards a user. In one example, the orientation may be either landscape or portrait.

In one example, the at least one second sensor 106 may be a contextual information sensor. For example, the contextual information sensor may collect information regarding a location of the device 100 (e.g., global positioning system (GPS) data), peer devices like Bluetooth® or WiFi access points around the device 100 when a specific application is being used, accelerometer data (e.g., whether the device 100 is moving, how fast the device 100 is moving, and the like), a name of an application that is open, an amount of time the application is open, a time of day, day of the week, and the like.

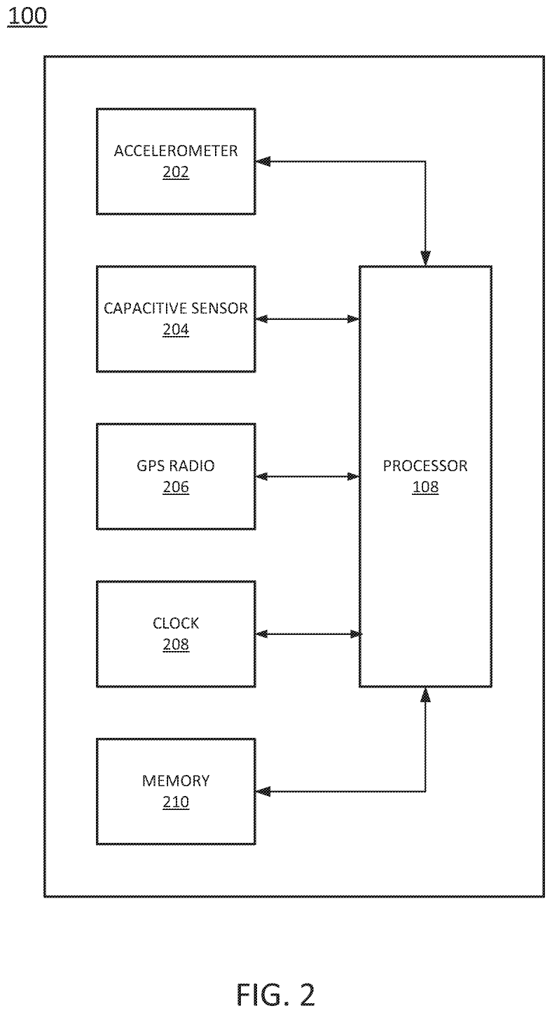

FIG. 2 illustrates a more detailed block diagram of the device 100. In one example, the at least one first sensor 104 may include an accelerometer 202 and a capacitive sensor 204 that are in communication with the processor 108. For example, the accelerometer 202 may collect positional information about the device 100, such as orientation, tilt angle, carry position, and the like. The capacitive sensor 204 may detect whether the device 100 is being held by a hand, a mount, and the like. For example, the capacitive sensor 204 may be located around the edges of the device 100.

In one example, the at least one second sensor 106 may also include the accelerometer 202, a GPS radio 206, a clock 208 and a memory 210 that are in communication with the processor 108. For example, the accelerometer 202 may provide contextual information such as whether or not the device 100 is moving, how fast the device 100 is moving, and the like. The GPS radio 206 may collect location information of the device 100. The clock 208 may provide a time and a date.

The memory 210 may include application programs that may be executed by the processor 108. Thus, each time an application is executed, the processor 108 may determine a name of the application. The processor 108 may also determine an amount of time the application is open and/or what day the application is open from the clock 208.

It should be noted that FIG. 2 illustrates a few examples of different sensors that can be deployed as sensors that collect device position information (e.g., the at least one first sensor 104) and contextual information (e.g., the at least one second sensor 106). It should be noted that other sensors or alternative sensors to the ones illustrated in FIG. 2 may also be deployed.

In one example, the memory 210 may also include settings of the device 100 that are executed by the processor 108. As noted above, portable devices may have an auto lock feature that includes a timer to automatically turn off the display 102 after a period of inactivity. For example, after one minute of inactivity the processor 108 may turn off the display 102 to conserve battery power.

However, the present disclosure allows the processor 108 to temporarily override or disable the timer for automatic control of the display 102, e.g., an auto lock feature. For example, when the processor 108 detects a usage pattern that indicates the display 102 should be kept on despite long periods of inactivity, then the automatic control of the display 102 may be temporarily disabled.

In one implementation, the processor 108 may collect the information from the at least one first sensor 104 and the at least one second sensor 106 to collect device position information and contextual information, respectively, during a learning period. The learning period may be any predetermined amount of time that is sufficient for the processor 108 to learn usage patterns of the device 100 (e.g., several days, one week, one month, and the like). In other words, pre-set tilt angles or usage patterns are not defined by the user. Rather, the device 100 can learn the usage patterns based off of normal use of the device 100 during the learning period without user interaction or user defined settings.

During the learning period, the processor 108 may identify patterns of use. For example, the processor 108 may identify that the user likes to open a reading application every night at 10:00 PM before going to bed at a location that is associated with the user's home. The device 100 may be tilted downward in a portrait orientation while the user is reading in bed.

In another example, the usage pattern may be simpler. For example, the processor 108 may learn that whenever the device is tilted away from the user in a landscape orientation and has a mail application or a Windows® tool application (e.g., Word®, Power Point®, Excel®, and the like) open that the inactivity timer to turn off the display 102 should be temporarily disabled. In another example, the processor 108 may learn that whenever the device 100 is held in a portrait orientation while device 100 is moving that the user is reading on the device while walking or riding in a vehicle (e.g., a train, car, plane, and the like).

In other examples, the usage pattern may be detected even if the device 100 is lying flat on a desk. For example, the user may use the device 100 to transcribe documents at work while the device 100 is lying flat on a desk. Thus, a usage pattern may be detected that when the tilt angle is 0 degrees or flat at an office location of the user during a weekday that the user is transcribing a document from the device 100.

Thus, during the learning period, the processor 108 may learn various different usage patterns, such as the examples described above. The usage patterns may be stored in the memory 210. The usage patterns may be associated with one or more pieces of information that is collected by the at least one first sensor 104 and the at least one second sensor 106.

It should be noted that the usage may not necessarily be labeled as “reading in bed,” “watching streaming video,” “reading on train,” “transcribing documents on a desk,” and the like. Rather, the usage pattern may be identified by a combination of the device position and the contextual information that is collected. In one example, a prompt may be provided by the processor 108 to identify a detected pattern. For example, during the learning period when the processor 108 learns a usage pattern, a prompt may be provided via the display 102 for the user to label the usage pattern that is learned by the processor 108.

After the learning period the processor 108 may monitor the usage of the device 100. For example, the processor 108 may collect the position information and the contextual information from the at least one first sensor 104 and the at least one second sensor 106, respectively, and determine if the information matches a set of information stored in the memory 210 that identifies a usage pattern. To illustrate, if the processor 108 collects information that the device 100 is being held in a portrait orientation and the accelerometer 202 detects that the device 100 is moving, the processor 108 may determine that this information matches information associated with a user reading while reading on a vehicle. Thus, the processor 108 may temporarily disable the auto lock feature that automatically turns off the display 102.

In other words, the inactivity timer of the auto lock feature may not be activated at all. Alternatively, the processor 108 may keep the display 102 on even after the inactivity timer of the auto lock feature expires.

In one example, the inactivity timer may be disabled or overridden temporarily for a period of time that is pre-defined after a timer of the auto lock feature has expired. For example, after the processor 108 detects the usage pattern a timer for reactivating the auto lock feature may be set for a period of time (e.g., 60 seconds, five minutes, and the like). After the period of time has expired, the processor 108 may determine if the usage pattern is still detected. If the usage pattern is still detected, the processor 108 may reset the timer for reactivation of the auto lock feature. If the usage pattern is not detected, the processor 108 may display a notification on the display 102 to determine if the user is still using the device 100. If the processor 108 does not receive a confirmation that the device 100 is in use, the processor 108 may then turn off the display 102 to conserve battery life.

In one implementation, if the processor 108 does not receive a confirmation that the device 100 is still in use despite the usage pattern still being detected, the display 102 may be turned off or the default settings for the auto-lock feature may be re-enabled. In one example, receiving no response to the notification may be considered as assuming that the device 100 is not in use. For example, a user may fall asleep while holding the device 100 in such a way that the processor detects a “reading in bed” usage pattern or the user may have the device 100 in a cradle while responding to an email, but forget to take the device 100 off of the cradle.

In another example, the period of time may be dynamically changed, or set, based on the usage pattern that is identified. For example, the processor 108 may learn that the user reads in bed at night for an average of 30 minutes. Thus, when the usage pattern is detected to be reading in bed, the timer may be set to a period of time of 30 minutes. In another example, the processor 108 may learn that the user watches streaming video while in a moving vehicle for an average of two hours. Thus, when the usage pattern is detected to be watching a streaming video in a moving vehicle, the timer may be set to a period of time of two hours, and so forth.

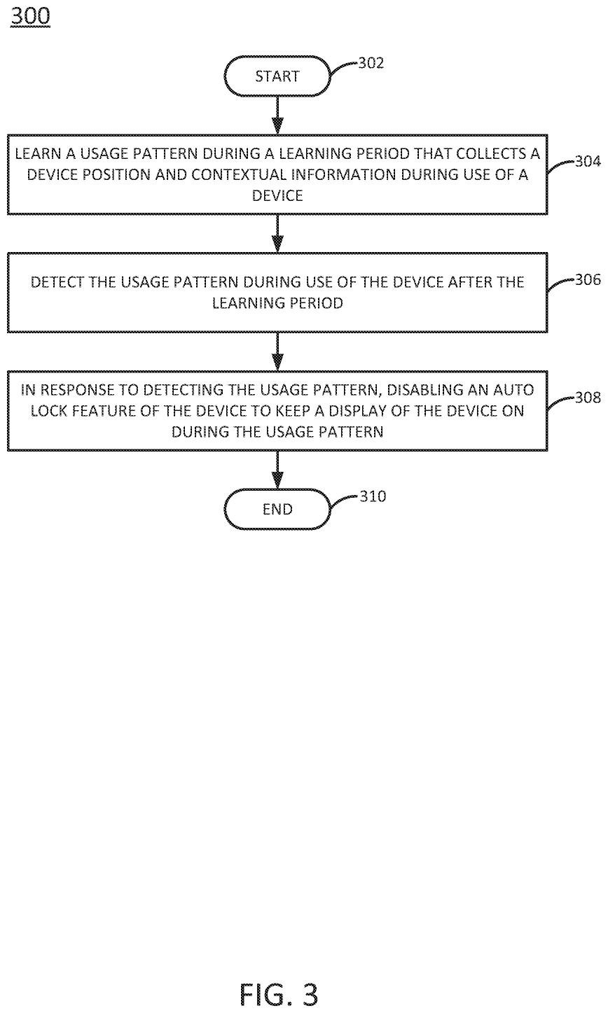

FIG. 3 illustrates a flow diagram of an example method 300 for keeping a display on. In one example, the method 300 may be performed by the processor 108 of the device 100 illustrated in FIGS. 1 and 2.

At block 302, the method 300 begins. At block 304, the method 300 learns a usage pattern during a learning period that collects a device position and contextual information during use of the device. For example, the learning period may be any period of time that is sufficient to learn the usage patterns of the device (e.g., a day, several days, a week, a month, and the like).

During the learning period, the device position and the contextual information may be collected by various different sensors on the device. The device position may include a tilt angle, an orientation, whether the device is being held, and the like. The contextual information may include accelerometer data, an application that is open, an amount of time the application is open, a time of day, a day of week, and the like.

The device may learn usage patterns based on the device position and the contextual information. For example, the device may learn that the user likes to read holding the phone tilted away from the user in a landscape orientation around 8:30 am every weekday at a home location. The device may learn that the user likes to read documents while the device is lying flat on a table when at a work location of the user. The device may learn that whenever a streaming video application is open and the device is in a landscape orientation that the user is watching a video on the device. The examples provided above are examples and other examples of usage patterns may be within the scope of the present disclosure.

At block 306, the method 300 detects the usage pattern during use of the device after the learning period. For example, after the learning period has concluded, the device may be continuously monitored. In other words, the processor of the device may continuously collect device position information and contextual information from the respective sensors and analyze the data to determine if the information matches information that is associated with a usage pattern.

At block 308, the method 300 disables an auto lock feature of the device to keep a display of the device on during the usage pattern in response to detecting the usage pattern. For example, when a match is found and a usage pattern is identified, the auto lock feature may be disabled. In other words, the display may be kept on despite long periods of inactivity (e.g., a time period greater than an inactivity timer associated with the auto lock feature).

In implementation, the auto lock feature may be disabled temporarily for a period of time. For example, the auto lock feature may be disabled for a period of time. After the period of time has expired the device may prompt the user to confirm that the usage pattern is no longer occurring (e.g., one minute, 30 minutes, one hour, and the like). If the user confirms that the usage pattern is still ongoing then the period of time may reset and the prompt may be repeated.

In implementation, the period of time may be dynamically changed based on the usage pattern that is detected. In other words, different usage patterns may be associated with different time periods. For example, a user may read at night in bed for an average of 30 minutes. Thus, after 30 minutes of detecting the usage pattern, the user may be prompted to confirm that the usage pattern is still ongoing. In another example, the user may transcribe documents from the device for an average of 2 hours. Thus, after two hours of detecting the usage pattern, the user may be prompted to confirm that the usage pattern is still ongoing.

Once the usage pattern is no longer detected, the auto lock feature may be re-enabled. As a result, for certain usage patterns, a user may continue to use the device without interruption by having the display automatically turn off due to inactivity. At block 310, the method 300 ends.

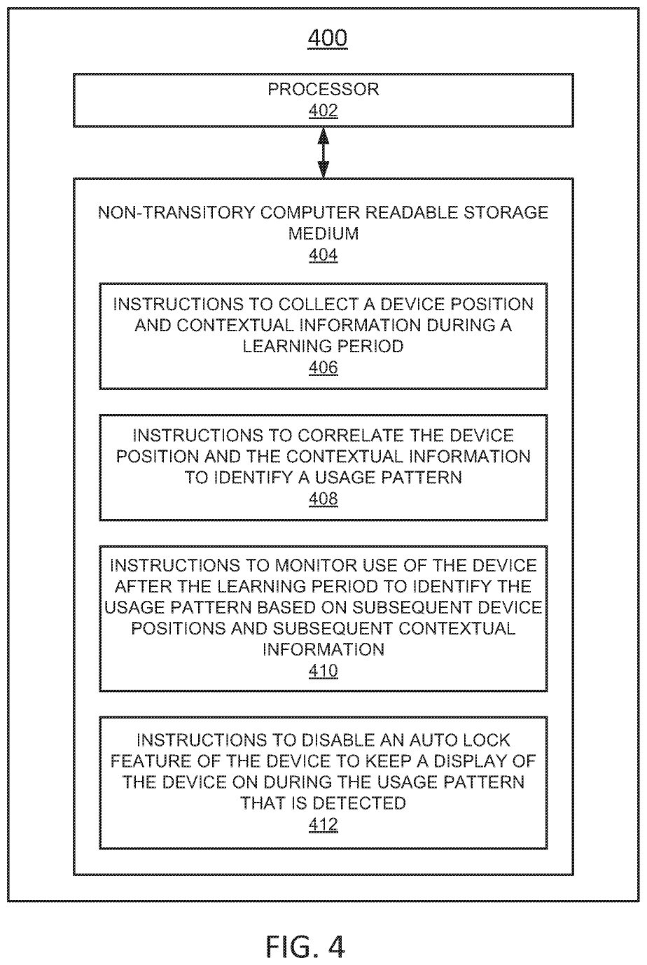

FIG. 4 illustrates an example of an apparatus 400. In one example, the apparatus may be the device 100. In one example, the apparatus 400 may include a processor 402 and a non-transitory computer readable storage medium 404. The non-transitory computer readable storage medium 404 may include instructions 406, 408, 410 and 412 that when executed by the processor 402, cause the processor 402 to perform various functions.

In one example, the instructions 406 may include instructions to collect device position and contextual information during a learning period. The instructions 408 may include instructions to correlate the device position and the contextual information to identify a usage pattern. The instructions 410 may include instructions to monitor use of the device after the learning period to identify the usage pattern based on subsequent device position and subsequent contextual information. The instructions 412 may include instructions to disable an auto lock feature of the device to keep a display of the device on during the usage pattern that is detected.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
learning a usage pattern during a learning period that collects a device position and contextual information during use of a device;
detecting the usage pattern during use of the device after the learning period; and
in response to detecting the usage pattern, disabling an auto lock feature of the device to keep a display of the device on during the usage pattern.

2. The method of claim 1, wherein the device position comprises a tilt angle, an orientation, or whether the device is being held.

3. The method of claim 1, wherein the contextual information comprises a location, a peer device, accelerometer data, an application that is open, an amount of time the application is open, or a time of day.

4. The method of claim 1, wherein the auto lock feature is disabled for a period of time.

5. The method of claim 4, wherein the period of time is based on the one of the usage pattern that is detected or pre-defined.

6. A device, comprising:
a display;
a first sensor to collect a device position during a learning period;
a second sensor to collect contextual information during the learning period; and
a processor in communication with the display, the at least one first sensor and the at least one second sensor to identify a usage pattern based on the device position and the contextual information, detect the usage pattern when the device is in use after the learning period, and keep the display on past a timer of an auto lock feature when the usage pattern is detected.

7. The device of claim 6, wherein the device position comprise a tilt angle, an orientation, or whether the device is being held.

8. The device of claim 6, wherein the contextual information comprises a location, a peer device, accelerometer data, an application that is open, an amount of time the application is open, or a time of day.

9. The device of claim 6, the processor is to turn off the display when detection of the usage pattern fails.

10. The device of claim 6, the processor to turn off the display after a period of time after the timer of the auto lock feature has expired.

11. The device of claim 10, wherein the period of time is based on the usage pattern that is detected or pre-defined.

12. A non-transitory computer readable storage medium encoded with instructions executable by a processor of, the non-transitory computer-readable storage medium comprising:
instructions to collect a device position and contextual information during a learning period;
instructions to correlate the device positions and the contextual information to identify a usage pattern;
instructions to monitor use of the device after the learning period to identify the usage pattern based on subsequent device positions and subsequent contextual information; and
instructions to disable an auto lock feature of the device to keep a display of the device on during the usage pattern that is detected.

13. The non-transitory computer readable storage medium of claim 12, wherein the device position comprise a tilt angle, an orientation, or whether the device is being held.

14. The non-transitory computer readable storage medium of claim 12, wherein the contextual information comprises a location, a peer device, accelerometer data, an application that is open, an amount of time the application is open, or a time of day.

15. The non-transitory computer readable storage medium of claim 12, comprising:
instructions to turn off the display when detection of the usage pattern fails.
